(19) United States
(12) Patent Application Publication
(10) Pub. No.: US 2025/0333350 A1
(43) Pub. Date: Oct. 30, 2025

(54) MULTILAYER STRUCTURE FOR HARD COATING

(71) Applicant: SEAGATE TECHNOLOGY LLC, Fremont, CA (US)

(72) Inventors: Samuel D. Harkness, IV, El Cerrito, CA (US); Thomas P. Nolan, Fremont, CA (US); Jae Ha Choi, Pleasanton, CA (US); Judd Plutowski, Sunnyvale, CA (US); Zachary W. Lyons, Santa Clara, CA (US); Anahita Goshtasbi, San Jose, CA (US); Yi Xin Han, San Jose, CA (US); Sonia Sanchez, Milpitas, CA (US); James A. Sullivan, Santa Clara, CA (US)

(21) Appl. No.: 19/189,117

(22) Filed: Apr. 24, 2025

Related U.S. Application Data
(60) Provisional application No. 63/638,288, filed on Apr. 24, 2024.

(51) Int. Cl. C03C 17/34; C03C 17/22; C03C 17/245; C03C 17/36

(52) U.S. Cl. CPC C03C 17/3435; C03C 17/225; C03C 17/245; C03C 17/3417; C03C 17/3657; C03C 2217/281; C03C 2218/15; C03C 2218/154

(57) ABSTRACT

A film layer is disclosed having a graded index of refraction and layer stacks, along with processes and apparatuses for making film layers. The graded index of refraction may have a continuous change through thickness of the film layer. The film layer may be made of a cation oxynitride material. Film layers may be made by using a sputtering source and varying gas flows over time, or by moving or positioning a substrate within PVD zones having lower and higher index of refraction material deposition.

### CROSS-REFERENCE TO RELATED APPLICATIONS

This application claims benefit of priority from U.S. Provisional Application No. 63/638,288 titled “MULTILAYER STRUCTURE FOR HARD COATING” and filed Apr. 24, 2024, which is hereby incorporated by reference.

### TECHNICAL FIELD

The technical field of the present disclosure relates to film layers, more specifically optical film layers, and processes and apparatus for making film layers or optical film layers.

### BACKGROUND

Anti-reflective coatings can improve the optical performance of display panels, but their nature elevates the need for lower defectivity. Scratch resistance is thereby an important component to consumer optical coating design. A common design approach is to add hardness to strategically placed layers within a coating stack, e.g., a stack of layers forming a coating. However, the optical properties of these hard coating layers also contribute to the overall performance.

Optical coatings for display panels may be formed by depositing film layers on glass or other optical substrate, for example by physical vapor deposition (PVD). Typically, there are trade-offs for a given layer in material choice, hardness, index of refraction, layer thickness, etc., and trade-offs in combinations of layers. Also, there are considerations for manufacturing efficiency and throughput which may affect the films, such as trade-offs for stationary substrate versus moving substrate with transport mechanism, single stage versus multi-stage, etc.

### SUMMARY

Disclosed herein are embodiments of a film layer having a graded index of refraction and layer stacks. Also disclosed are processes and apparatuses for making film layers. Some embodiments include a cation oxynitride material. Some embodiments are made by physical vapor deposition (PVD), a sputtering source, varying gas flows, and/or substrate positioning.

One embodiment is a film layer having a graded index of refraction through a thickness of the film layer. The film layer includes an upper portion, a middle portion, and a lower portion. The upper portion of the thickness of the film layer has a lower index of refraction, of the graded index of refraction. The middle portion of the thickness of the film layer has a higher index of refraction, of the graded index of refraction. The lower portion of the thickness of the film layer has a lower index of refraction, of the graded index of refraction.

One embodiment is a film layer stack. The film layer stack has an anti-reflective layer, a hard overcoat layer and an adhesion layer. The anti-reflective layer has single-layer or multilayer structure or sub-structure and uniform or nonuniform structure or sub-structure. The hard overcoat layer has single-layer or multilayer structure or sub-structure and uniform or nonuniform structure or sub-structure. The adhesion layer has single-layer or multilayer structure or sub-structure and uniform or nonuniform structure or sub-structure. The anti-reflective layer, the hard overcoat layer or the adhesion layer includes at least one graded index of refraction layer. The graded index of refraction layer has index of refraction graded through the layer thickness.

One embodiment is a film layer stack. The film layer stack has first and second layers. Each of the second layers is sandwiched by such first layers. Such first layers have lower index of refraction than such second layers. Each of the second layers has a graded index of refraction through a thickness of the second layer. An upper portion of the thickness of the second layer has a lower index of refraction, of the graded index of refraction. A middle portion of the thickness of the second layer has a higher index of refraction, of the graded index of refraction. A lower portion of the thickness of the second layer has a lower index of refraction, of the graded index of refraction.

Other aspects and advantages of the embodiments will become apparent from the following detailed description taken in conjunction with the accompanying drawings which illustrate, by way of example, the principles of the described embodiments.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1(a) is a schematic diagram of a layer sequence.

FIG. 1(b) is a block showing integration of layers.

FIG. 1(c) is showing integration of a plurality of layer combinations.

FIG. 2(a) is a plot showing potential variation of index of refraction is a function of layer depths of the envisaged combination of layers.

FIG. 2(b) is a stack diagram demonstrating integration of one embodiment of block in terms of index of refraction.

FIG. 3 is a schematic diagram showing an embodiment of a scratch-resistant

antireflective coating stack combining elements of setting layers, novel hard layer, and anti-reflective stack.

FIG. 4 depicts a PVD chamber and gas flow profile, which may be used to make layers described herein, in various embodiments.

FIG. 5 depicts a multi-stage apparatus, with multiple PVD chambers, which may be used to make layers described herein, in various embodiments.

FIG. 6 depicts a further PVD chamber, which may be used to make layers described herein, in various embodiments.

FIG. 7 depicts a still further PVD chamber, which may be used to make layers described herein, in various embodiments.

FIG. 8 depicts embodiments of a layer stack that can have graded layer(s), which can be composite layer(s) or bi-layer(s).

FIG. 9 depicts a stack of bi-layers, which has a zigzag index of refraction, in embodiments.

FIG. 10 depicts a multi-stage apparatus, with multiple PVD chambers, which may be used to make a stack of bi-layers using various gas flow profiles, in embodiments.

### DETAILED DESCRIPTION

Optical coatings, in the form of layers on glass or other substrate can enhance the base material by adding desirable properties, including durability (e.g., material hardness, scratch resistance) and/or glare reduction (e.g., anti-reflective material). Consumers want and expect high quality. An optical coating that has anti-reflective properties but is easily scratched (low scratch resistance) is perceived as lower quality. A hard, scratch resistant optical surface that has high glare may also be perceived as lower quality.

Embodiments of the invention described herein provide good anti-reflective properties with a hard and scratch-resistant optical surface. Embodiments described herein enable both mechanical hardness and ease in optical stack integration through the use of a composite layer, and coating stacks combining further layers with one or more such composite layers. Manufacturing apparatuses and processes described herein, and variations thereof, can form such composite layers and coating stacks.

In the field of optical coatings, a glass substrate (e.g., a display panel, a lens, etc.) will have one or more adhesion layers, then a hard layer, and one or more anti-reflective coating layers. Each layer is typically uniform in composition and may be applied by physical vapor deposition (PVD), e.g., through sputtering in a PVD chamber. The typical PVD chamber has a sputter source as a cathode, the substrate is positioned relative to the cathode and an anode, and a gas may be introduced to combine with sputtered material to form sputtered species that deposits on the substrate.

Silicon nitride, which may be formed by sputtering silicon (e.g. PVD with a silicon target) through nitrogen gas and deposited as a layer, is very hard and has a high index of refraction. Silicon dioxide, which may be formed by sputtering silicon through oxygen gas and deposited as a layer, is very soft and has a low index of refraction. Multiple layers, each uniform but with differing indexes of refraction, may have anti-reflective properties.

A material made of silicon dioxide (SiO₂) and silicon nitride (Si₃N₄) is called silicon oxynitride (SiOₓN_{y}). In amorphous forms it can continuously vary in composition between silicon dioxide and silicon nitride. The single silicon is the cation, for silicon oxynitride. Titanium or aluminum can also be used for a cation. This class of materials is called cation oxynitrides. Titanium, aluminum and other materials may be alloyed together, combined with silicon, or used individually as the cation material of the sputter target. Silicon dioxide has a refractive index of about 1.46. Silicon nitride has a refractive index of about 2.07 or 2.1. Both of these materials are transparent in visible light and can be used for optical coatings based on layer stacks with different refractive index patterns.

One, simple anti-reflective coating is a quarter wavelength plate using a quarter wave plate of high index of refraction material such as silicon nitride and then a quarter wave plate of low index of refraction material such as silicon oxide or more specifically silicon dioxide, which allows lowering the normal reflection of the interface from perhaps 5% to below 1%. The combination of quarter wave plates arranges the optical devices (e.g., films) for destructive interference and thus anti-reflective properties. Silicon nitride is a very hard material, several times (perhaps three times) harder than silica or quartz glass (e.g., silicon dioxide). Silicon nitride is good as an anti-scratch coating.

Sometimes it is desired to have material that is not as brittle as silicon, so a percentage, perhaps 10%, aluminum can be added to a silicon target (e.g., in a PVD sputtering source) to produce, e.g. silicon 90 aluminum 10 oxide. This may result in little change in refractive index. Similarly, with silicon aluminum oxynitride, or silicon aluminum nitride, there may be a 2.06 refractive index for nearly identical absorption. Similar antireflective or hard overcoat films can be made using oxides of silicon, aluminum, titanium, tantalum and zirconium. Choosing among these materials may allow varying mechanical properties while keeping optical properties.

In working with silicon oxynitride and other cations and working with cation oxynitrides about halfway between refractive index 1.5 and 2.1, for example in the vicinity of 1.8, one might expect the hardness to be halfway in between as well. For embodiments of the present invention, however, the hardness can be, for example, 80% of the way to the hardness of silicon nitride, which is very hard and also has a very high index of refraction. Making graded structures, multilayer, continuous multilayer structures according to the present embodiments provides a lower refractive index without losing hardness.

Specifically, a film, coating or composite layer made to have a graded index of refraction, such that the middle (of the layer thickness) has a higher index of refraction and the outer portions (upper and lower portions of layer thickness) have a lower index of refraction, acts like a lower index of refraction material but with hardness or scratch resistance closer to that of a higher index of refraction material. This composite layer with graded index of refraction through the thickness of the layer has useful anti-reflection properties and useful hardness or scratch resistance and is thus an improvement over the properties of a uniform layer having a single index of refraction and hardness associated with that index of refraction. Embodiments of layers, apparatuses, and processes are further described below.

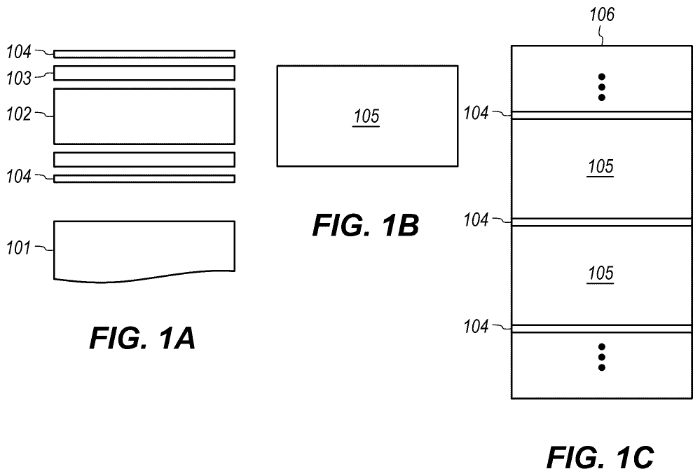

FIG. 1(a) is a schematic diagram of a layer sequence. A glass or other material substrate 101 is prepared for deposition and resulting film adhesion. A core material to be applied as a film upon substrate 101 has a unit structure, which contains a core layer 102 that is describable in terms of index of refraction and intrinsic hardness. To facilitate scratch resistance of the full stack structure, layer 102 has an intrinsic hardness in excess of 16 GPa (Gigapascal) as measured with a nano-indenter analyzer machine. Adjacent to layer 102 (e.g., above in the stack) is a transition layer 103. Transition layers 103 may be found on shouldering sides of the core layer 102. All layers described in this example are parallel to the surface of the substrate 101. Transition layers 103 exhibit a change in index of refraction across the layer. The index of refraction is differentiable from the center of the core layer 102 to the end of the transition layer 103. Said another way, the change of index of refraction is continuous in the region described above. The arrangement as envisaged in this art is shown in FIG. 1(a).

FIG. 1(b) is a block showing integration of layers. Together layers 102 and 103 in FIG. 1(a) form a unit layer 105 as shown in FIG. 1(b). This layer 105 forms the basic unit from which all manners of stack engineering ensue in terms of hardness and optical rendering. In FIG. 1(a), adjacent or below layers 102 and 103 (e.g., unit layer 105) lies a layer 104 of lower index of refraction material. Layer 104 is discretely different in index of refraction at the interface with layer 105 and more specifically as related to the terminal side of 103. It is most common in the practice of this art to observe an index of refraction below 1.6 for layer 104. From an optical perspective, the incorporation of these mortaring layers (e.g., layer 104) enables an interdigitation of the medium and thereby provides a mechanism to control and/or remove optical gradients as the light traverses in reflection and transmission. From a hardness perspective, the inclusion of these materials is causal to a softening trend. Therefore, the thickness of layer 104 is found most efficacious below 10 nm.

FIG. 1(c) is showing integration of a plurality of layer combinations. In pursuit of higher scratch resistance, stack designers will likely choose to generate thicker hard layers. The art described herein is replicated to form a plurality of layers 105 in combination with layers 104. This is shown in FIG. 1(c) as block 106, composed of alternating layers 104, 105. This technique affords flexibility in coating thickness without compromise in optical or mechanical terms.

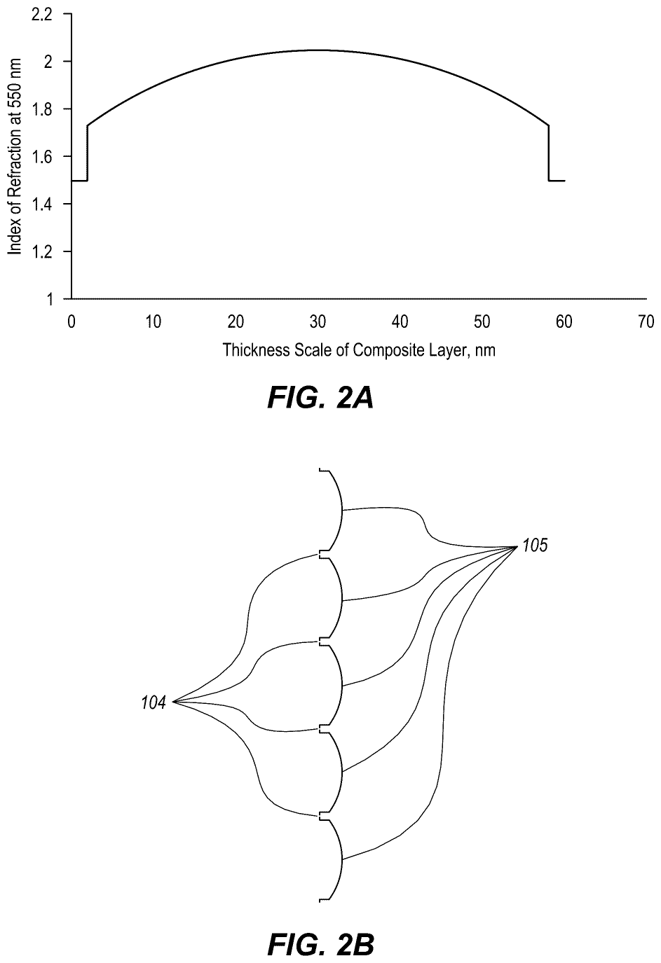

FIG. 2(a) is a plot showing potential variation of index of refraction is a function of layer depths of the envisaged combination of layers. For example, the plot can be read as describing index of refraction between 1.4 and 1.6, e.g., around 1.5, as a constant value for a very thin layer from zero to a few nanometers in height (i.e., thickness about 3 nm), followed by a graded index of refraction through a much thicker layer from a few nanometers to around 60 nm in height (i.e., thickness about 57 nm) with the index of refraction varying from below 1.8, e.g., about 1.75, up to greater than 2, e.g., about 2.05, and back down to below 1.8, e.g., about 1.75, followed by index of refraction between 1.4 and 1.6, e.g., around 1.5, as a constant value for a very thin layer from about 60 nm to about 63 nm height (i.e., thickness about 3 nm). The plot corresponds to a layer 104, a layer 105, and a layer 104 in a layer stack. Processes and apparatuses to achieve such a graded index of refraction through a thicker, composite layer (e.g., layer 105), as singular, in multiplicity, and/or in combination with further layers, are further described below.

FIG. 2(b) is a stack diagram demonstrating integration of one embodiment of block in terms of index of refraction. Between adjoining blocks of layer(s) 105 lies a layer 104 of lower index of refraction material. To interpret the stack diagram, consider the plot of FIG. 2(a) rotated clockwise 90°, and repeated vertically for each of multiple layers 105 and layers 104 therebetween, so that the stack diagram in FIG. 2(b) shows variation of index of refraction as a function of layer depths of the stack of multiple layers 104, 105. This may relate to block 106 composed of alternating layers 104, 105, depicted in FIG. 1(c), or variation thereof.

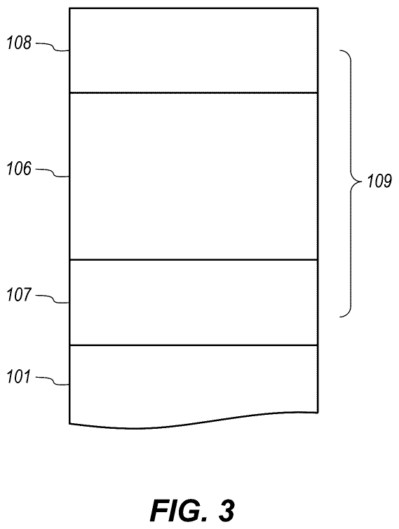

FIG. 3 is a schematic diagram showing an embodiment of a scratch-resistant antireflective coating stack combining elements of setting layers, novel hard layer, and anti-reflective stack. As a further embodiment of the disclosed technology, the hard layer block 106 is incorporated in a larger stack constructed to yield high adhesion, and high optical rendering. In this embodiment, a sub-stack of layers 107 is deposited upon substrate 101 to form a basis for adhesion of the block 106 in addition to the promotion of high optical transmittance across the spectral range of wavelengths including the visible and infrared (e.g., 400-1000 nm). Following the deposition of the blocks, i.e., sub-stack of layers 107 and then hard layer block 106, an anti-reflective coating sub-stack 108 is applied. A typical formulism herein involves the fabrication of alternating low and high index of refraction materials to facilitate the destructive interference of reflecting light. These sub-stacks or blocks, (i.e., sub-stack of layers 107, hard layer block 106, sub-stack 108) integrate to form a full stack rendering scratch-resistant anti-reflective coating 109 on substrate 101.

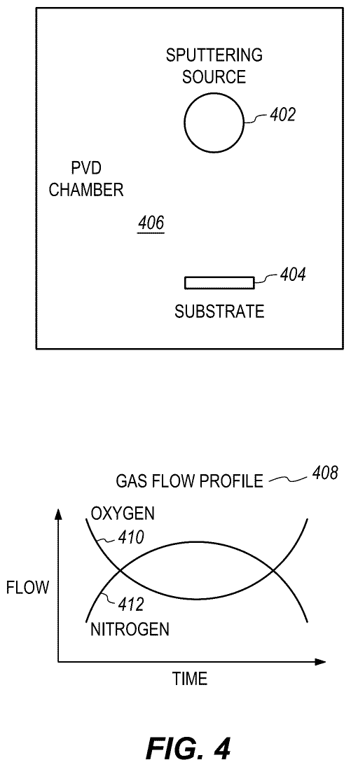

FIG. 4 depicts a PVD chamber and gas flow profile, which may be used to make layers described herein, in various embodiments. A substrate 404, e.g., glass, is positioned within a PVD chamber 406, to receive physical vapor deposition of one or more layers as a coating. For example, the substrate 404 may be held by a carrier, mounting, support, or transport mechanism (not shown but readily devised), and positioned relative to a sputtering source 402 that has a sputtering target, e.g., silicon, aluminum, or titanium. An electric field may be introduced, so that the sputtering source 402 is operated as a cathode, generating or providing cations, which can combine with an introduced gas to form PVD species that are then deposited on the substrate 404. For one embodiment, gas is introduced to the PVD chamber 406, for the formation of PVD species and deposition, and the gas is introduced according to a gas flow profile 408.

In this example, the gas flow profile 408 begins with a higher level of oxygen flow 410, and a lower level of nitrogen flow 412, which causes a higher oxide and lower nitride ratio of oxynitride species to form and be deposited on the substrate 404. For example, where silicon is used in the sputtering source 402, the early (e.g., initial) gas flow causes silicon oxynitride species of high silicon oxide and low silicon nitride ratio to deposit in a lowermost layer on the substrate 404. There may also be prior deposited layers on the substrate 404, such as an adhesion layer or sub-layers, for various embodiments.

As time advances, the gas flow profile 408 varies to increase level of nitrogen flow 412 and decrease level of oxygen flow 410, so that the middle of the gas flow profile 408 has higher level of nitrogen flow 412 and lower level of oxygen flow 410. This causes a higher nitride ratio, e.g., higher silicon nitride ratio, and lower oxide ratio, e.g., lower silicon dioxide ratio, in the oxynitride, e.g., silicon oxynitride, to deposit in a middle layer of the composite layer being formed on the substrate 404.

Continuing with advancement of time, the gas flow profile 408 varies to decrease level of nitrogen flow 412 and increased level of oxygen flow 410, so that the later-time values of the gas flow profile 408 have lower level of nitrogen flow 412 and higher level of oxygen flow 410, relating (but not necessarily identical) to the early or initial gas flow. This causes a higher oxide and lower nitride ratio of oxynitride species to form, e.g., higher silicon dioxide and lower silicon nitride ratio of silicon oxynitride, which is deposited on an uppermost layer of the composite layer being formed on the substrate 404.

For one embodiment, the gas flow profile 408 is gradually and continuously varied, which produces a gradual and continuously varied grading or gradation of oxynitride relative to oxide to nitride ratio, and associated grading or gradation of hardness of the material. Likewise, this produces a gradual and continuously varied grading or gradation of associated refractive index of the material, across the thickness of the composite layer. Particularly, gradations of the sort depicted in FIG. 2(a), and variations thereof, can be produced with this apparatus and process. And, multiple such layers can be deposited through multiple uses of apparatus and process, or passes of a substrate through a multi-chamber apparatus, etc.

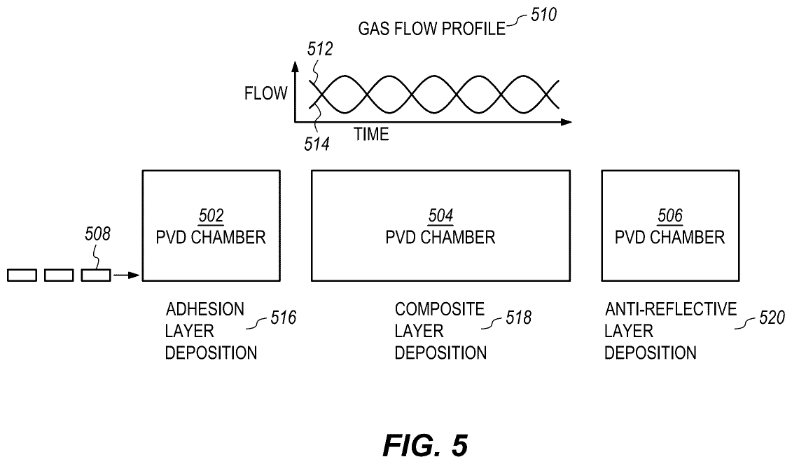

FIG. 5 depicts a multi-stage apparatus, with multiple PVD chambers, which may be used to make layers described herein, in various embodiments. Substrates 508 are moved and positioned in each of multiple PVD chambers 502, 504, 506, for example by a transport mechanism (not shown but readily devised), for processing as follows. In one PVD chamber 502, adhesion layer deposition 516 is performed, for example using appropriate sputtering source and operation. In the next PVD chamber 504, composite layer deposition 518 is performed, for example using a gas flow profile 510 that varies oxygen flow 512 and nitrogen flow 514 in time as depicted. That is, oxygen flow and nitrogen flow are varied multiple times in a complementary manner, one increasing while the other decreases and vice versa, in multiple cycles over time. And in the next PVD chamber 506, anti-reflective layer deposition 520 is performed, using appropriate sputtering source and operation.

The gas flow profile 510 is related to the gas flow profile 408 of FIG. 4, but repeats rather than performing only a single cycle, and causes formation and deposition of multiple composite, graded layers, or relatedly a single multiply graded composite layer, such as depicted in FIG. 1(c) and FIG. 2(b). Although depicted as approximately sinusoidal, the gas flow profile 510 may vary with other shapes such as triangular, piecewise linear, various curves, various scales, etc.

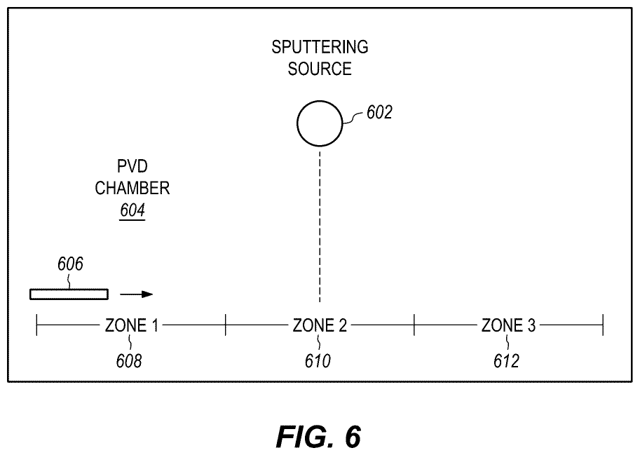

FIG. 6 depicts a further PVD chamber, which may be used to make layers described herein, in various embodiments. A substrate 606 is positioned in various zones 608, 610, 612 in a PVD chamber 604, relative to a sputtering source 602. For example, the substrate 606 could be mounted to a transport mechanism (not shown), and moved continuously or moved to discrete positions, or combination. There may be fewer or more zones, for example there may be but a single zone but continuous movement therethrough, etc., in variations. An example electric field of 300 KeV may be used for driving implantation of PVD species into the substrate 606.

PVD species (e.g., as discussed above or variants) arrive at a substrate 606 in one zone 610, “zone 2”, having experienced fewer collisions and having higher energy, which causes denser material deposition on the substrate 606, with higher index of refraction. PVD species arrive at substrate 606 in other zones 608, 612, “zone 1” and “zone 3” respectively, having experienced more collisions with gases and having lower energy, due to longer travel path and travel time, which causes less dense material deposition on the substrate 606, with lower index of refraction.

A substrate 606 positioned in or moved through zones 608, 610, 612, i.e., zone 1, zone 2 and zone 3, experiences formation of a composite, graded layer as a coating, in keeping with embodiments described herein. This composite layer has graded index of refraction, lower index of refraction, higher index of refraction, lower index of refraction, through the thickness of the layer. To form multiple such composite layers, multiple passes, a back and forth motion, other repeated or varied positioning of the substrate, etc., may be used in various embodiments.

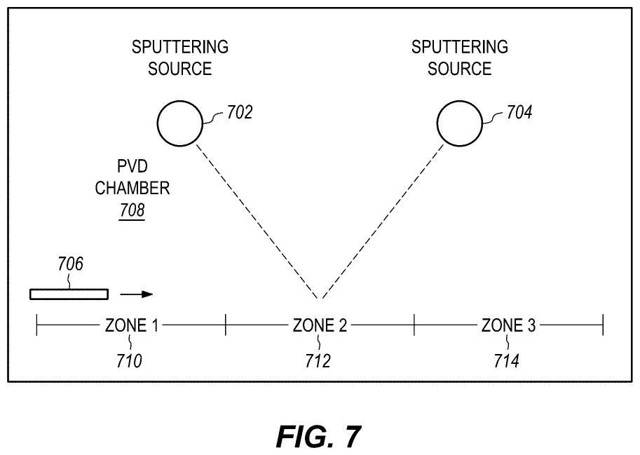

FIG. 7 depicts yet another PVD chamber, which may be used to make layers described herein, in various embodiments. This embodiment uses two sputtering sources 702, 704, although further embodiments with other numbers of sputtering sources may be devised. A substrate 706 moves through or is positioned in each of multiple zones 710, 712, 714, e.g., “zone 1”, “zone 2”, “zone 3”, related to the zones 608, 610, 612 of FIG. 6. Having two sputtering sources 702, 704 may increase PVD species density, rate of deposition, layer uniformity, throughput of substrates 706, deposition layer thickness, etc., or have further benefits.

The highest energy atoms or ions from the sputter are at the center of the PVD chamber 708, causing the higher index of refraction material to be deposited on the substrate 706 when in the zone 712 labeled “zone 2”. Lower energy atoms or ions in the sputter are at outer edges of the PVD chamber 708, causing the lower index of refraction material to be just deposited on the substrate 706 when in the zones 710, 714 labeled “zone 1” and “zone 3”. Moving or positioning the substrate 706 through the PVD chamber 708 causes the build up of a thick composite layer, with lower index of refraction material, then higher index of refraction material, then lower index of refraction material (e.g., bottom, middle, top portions of the thick composite layer). Multiple passes can build multiple thick composite layers. A multi-station variation of the apparatus could have each sputtering a layer. Varied composition of gas and/or varied pressure over time can also create low, high, low density composite layers, which principal and operation can be applied to other embodiments described herein and variations.

Above-described processes, arrangements and features may be applied to modify or carry out operations on existing equipment used to make optical coatings or hard disk drive discs, and other deposition systems, for various embodiments readily devised in keeping with the teachings herein. These embodiments enable production of a material, more specifically a composite layer film, that has properties of 16 Gigapascal hardness and below 1.8 index of refraction. These embodiments enable production of a film layer with a graded index of refraction and an average index of refraction, measured at a wavelength of 550 nm, that is greater than 1.7. These embodiments enable production of a film layer that has a low extinction coefficient, k, in the electromagnetic spectrum wavelength range 400 nm to 1200 nm, and at 400 nm, k<0.0001. These and further materials may be suitable for use as an optical coating or a member of an optical coating, with desirable properties for anti-reflection and scratch resistance.

Below are described further embodiments of graded index of refraction layers, specifically a type of graded layer, composite layer or gradient layer, termed bi-layer, a stack of bi-layers, apparatus and process embodiments for making bi-layers and stacks of bi-layers. Where the above-described graded index of refraction layer has index of refraction graded, gradient or varied through the thickness of the layer from lower index of refraction to higher index of refraction to lower index of refraction (see FIGS. 2A, 2B), below-described graded index of refraction layers have index of refraction graded, gradient or varied through the thickness of the layer from lower index of refraction to higher index refraction, or from higher index of refraction to lower index of refraction. These, too, are useful in single or multiple layers, for hardness and antireflective properties, for example in optical coatings also called layer stacks (or just stacks).

In researching and developing embodiments described herein, it was found that the graded index and alternating index multilayers or thin bi-layers of different refractive index provide a hardness and toughness of the layer structure that is greater than that of a single uniform layer having the same apparent measured refractive as the graded or bi-layer/multilayer structure.

Thus, an optical stack that may include a series of adhesion layers, hard layers and antireflective layers may be constructed by replacing some or all of the individual layers of the optical stack with corresponding graded layers, bi-layers or multilayers formed by various methods such as those disclosed, and the resulting stack of index equivalent layers can be made to be harder and more fracture tough than the optically equivalent stack of uniform single layers.

Research and development for the embodiments further indicates this same improvement path should be generally applicable to Si, SiAl, Ti, Zr, Ta, Al, and many other transparent oxide/nitride capable cation targets. It should be generally applicable to hard layers, adhesion layers, and antireflective layers. It should be generally applicable to any index regimes that can be addressed by the different materials sets available. It should be generally applicable to any number of reactive sputtering systems, cathode designs and reactive gas incorporation methods.

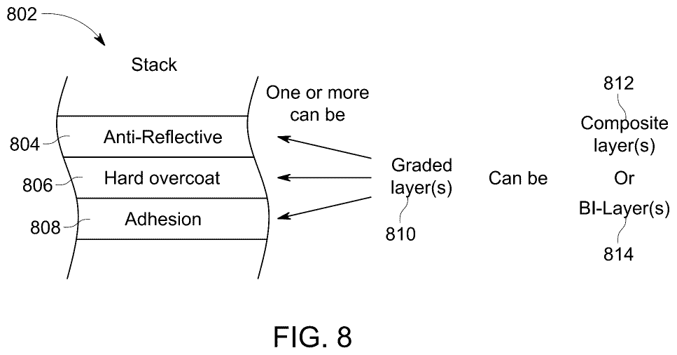

FIG. 8 depicts embodiments of a layer stack 802 that can have graded layer(s), which can be composite layer(s) 812 or bi-layer(s) 814. Generally, the layer stack 802, which could be atop a substrate as an optical coating, has an adhesion layer 808 or adhesion layer structure, a hard overcoat layer 806 or hard overcoat structure, and an anti-reflective layer 804 or anti-reflective structure.

It is noted throughout the term of art “layer” can have singular or collective meaning, and may include layers or sub-layers, which may each be a layer in the same sense. Within this general meaning, a layer can have single-layer or multilayer structure or sub-structure, uniform or nonuniform structure or sub-structure, etc. A layer may have more complex sub-structures that may include several distinct layers or graded layers, for example as described herein in embodiments. Embodiments described herein may apply to many other anti-reflective structures designed to optimally provide specified anti-reflection properties over selected larger or different regions of the optical spectrum, that may be formed by selection of several layers of different thickness and refractive index according to optical reflection models in the art.

In various embodiments each of the layers 804, 806, 808 of the layer stack 802 can be one or more graded layers 810. And each graded layer 810 can be one or more composite layers 812, one or more bi-layers 814, or combinations thereof. That is, the embodiments depicted in FIG. 8 are many and varied with composite layer(s) 812 or bi-layer(s) 814 used in the hard overcoat layer 806, the anti-reflective layer 804 and/or the adhesion layer 808. One embodiment uses a stack of bi-layers 814 (e.g., four stacked bi-layers 814, or other number) for or in the hard overcoat layer 806. It is understood the adhesion layer 808 has the functionality of adhering the remainder of the stack 802, to a substrate. The hard overcoat layer 806 has the functionality of having hardness, and over coating the substrate (whether or not accompanied by an adhesion layer, in various embodiments). And, the anti-reflective layer 804 has the functionality of anti-reflection properties. Each, and various combinations of these, may benefit from use of either of these types of graded layers. Particularly, substituting in multiple composite layers or bi-layers, each with graded index of refraction through the thickness of the layer, in a thick, hard overcoat layer may benefit the layer stack.

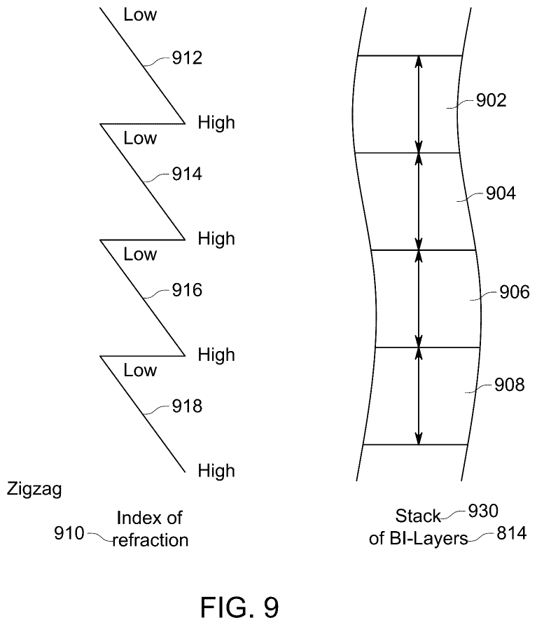

FIG. 9 depicts a stack 930 of bi-layers 814, which has a zigzag index of refraction 910, in embodiments. The stack 930, through the layers from top to bottom, has a bi-layer 902 with index of refraction 912 varied or graded from low to high, a bi-layer 904 with index of refraction 914 varied or graded from low to high, a bi-layer 906 with index of refraction 916 varied or graded from low to high, and a bi-layer 908 with index of refraction 918 varied or graded from low to high. This example has four bi-layers 814, and examples with other numbers of bi-layers are readily envisioned. A variation could have index of refraction varied or graded from high to low, high to low, high to low, etc., going from top to bottom of the stack. The shape of the zigzag index of refraction 910 could have a curve, for example an S curve, or other shapes readily envisioned.

Comparison of embodiments shows the stack 930 of bi-layers 814 of FIG. 9 and the stack of layers 104, 105 in FIGS. 1(c), 2(b) are related, as follows. The index of refraction from top to bottom through the thickness of the stack 930 of bi-layers 814 in FIG. 9 is graded low to high, graded low to high, graded low to high, graded low to high. The index of refraction from top to bottom through the thickness of the layers of the stack diagram in FIG. 2(b) is low, graded low to high to low, low, graded low to high to low, low, graded low to high to low, low, etc. These embodiments have in common each has multiple layers that each have a graded index of refraction varied from low to high, or varied from high to low, or both. That is, broadly, they share repetitions or multiples of a graded index feature.

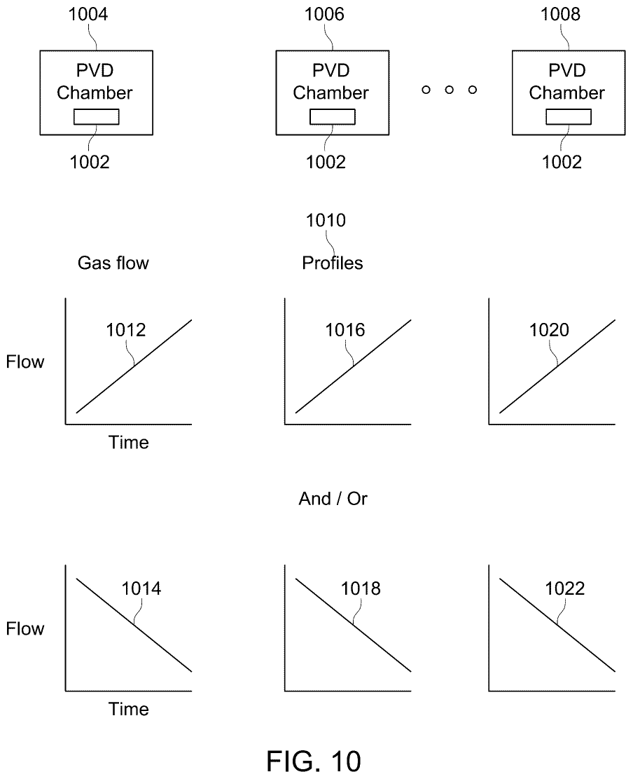

FIG. 10 depicts a multi-stage apparatus, with multiple PVD chambers, which may be used to make a stack of bi-layers using various gas flow profiles, in embodiments. Alternatively, a single-stage apparatus, such as single PVD chamber 404 as depicted in FIG. 4, could be used to make a stack of bi-layers using various gas flow profiles, for example keeping the substrate 404 in the PVD chamber 406 for multiple cycles of a varied gas flow.

Continuing with FIG. 10, in one embodiment the substrate 1002 is placed in PVD chamber 1004, for PVD using a gas flow 1012 that increases over time, or a gas flow 1014 that decreases over time. The deposition material grows in thickness as it is deposited on the substrate 1002, and varies in index of refraction through such thickness of layer according to the change in gas flow. Particularly, the gas flow profile 1010 is arranged to produce a low to high graded index of refraction through the thickness of the bi-layer deposited on the substrate 1002, or produce a high to low graded index of refraction, according to the embodiment.

Next, after the first bi-layer is deposited on the substrate 1002, the substrate 1002 is moved to the next PVD chamber 1006, for PVD using a gas flow 1016 that increases over time, or a gas flow 1018 that decreases over time. The process and resultant bilayer are as described above for the first PVD chamber 1004, for the next bi-layer.

And so on, the substrate 1002 is moved through one or more further PVD chambers 1008, for PVD using a gas flow 1020 that increases over time or a gas flow 1022 that decreases over time, however many are needed for however many bi-layers are to be deposited, so that the stack 930 of bi-layers 814 depicted in FIG. 9 is produced on the substrate 1002. In variations, gas flow profiles 1010 can be varied for different properties, two gases can be used (e.g., see FIG. 4), a substrate could be cycled multiple times in one of the PVD chambers before or after moving through one or more other PVD chambers, etc.

Further embodiments of apparatus and process for making bi-layers, stacks of bi-layers, layer stacks with zigzag index of refraction or other graded index of refraction profiles are readily devised in keeping with the teachings herein. For example, using half of the gas flows of FIG. 4 for a single PVD chamber embodiment, modifying the gas flows of FIG. 5 for a multi-stage embodiment, stopping or starting sputtering halfway through the PVD chamber of FIG. 6 or FIG. 7, relocating a sputtering source, modifying sputtering voltage, etc., could make such layers or variations thereof.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified.

What is claimed is:

1. A film layer having a graded index of refraction through a thickness of the film layer, comprising:
an upper portion of the thickness of the film layer, having a lower index of refraction of the graded index of refraction;
a middle portion of the thickness of the film layer, having a higher index of refraction of the graded index of refraction; and
a lower portion of the thickness of the film layer, having a lower index of refraction of the graded index of refraction.

2. The film layer having the graded index of refraction through the thickness of the film layer of claim 1, wherein:
the graded index of refraction has a continuous change in index of refraction through the thickness of the film layer.

3. The film layer having the graded index of refraction through the thickness of the film layer of claim 1, wherein:
the film layer has an average index of refraction, measured at a wavelength of 550 nm, that is greater than 1.7.

4. The film layer having the graded index of refraction through the thickness of the film layer of claim 1, wherein:
the film layer comprises a cation oxynitride material with hardness exceeding 14 GPa (Gigapascals).

5. The film layer having the graded index of refraction through the thickness of the film layer of claim 1, wherein:
the film layer has a low extinction coefficient, k, in the electromagnetic spectrum wavelength range 400 nm to 1200 nm; and
at 400 nm, k<0.0001.

6. The film layer having the graded index of refraction through the thickness of the film layer of claim 1, wherein:
the film layer is between 2 nm and 200 nm in thickness.

7. The film layer having the graded index of refraction through the thickness of the film layer of claim 1, wherein:
the film layer comprises a cation oxynitride material layer.

8. A film layer stack, comprising:
an anti-reflective layer having single-layer or multilayer structure or sub-structure and uniform or nonuniform structure or sub-structure;
a hard overcoat layer having single-layer or multilayer structure or sub-structure and uniform or nonuniform structure or sub-structure; and
an adhesion layer having single-layer or multilayer structure or sub-structure and uniform or nonuniform structure or sub-structure;
wherein the anti-reflective layer, the hard overcoat layer or the adhesion layer comprises at least one graded index of refraction layer having index of refraction graded through a layer thickness.

9. The film layer stack of claim 8, wherein the hard overcoat layer comprises a plurality of such graded index of refraction layers.

10. The film layer stack of claim 8, wherein the graded index of refraction layer comprises a bi-layer having index of refraction graded from low to high, or from high to low, through the layer thickness.

11. The film layer stack of claim 8, wherein the graded index of refraction layer comprises a composite layer having index of refraction graded from low to high to low, through the layer thickness.

12. The film layer stack of claim 8, wherein the hard overcoat layer comprises a plurality of bi-layers each having index of refraction graded from low to high, or from high to low, through the layer thickness.

13. The film layer stack of claim 8, wherein the hard overcoat layer comprises a plurality of composite layers each having index of refraction graded from low to high to low, through the layer thickness.

14. A film layer stack, comprising:
a plurality of first and second layers, each of the second layers sandwiched by such first layers, such first layers having lower index of refraction than such second layers;
each of the second layers comprising a cation oxynitride material layer; and
each of the second layers having a graded index of refraction through a thickness of the second layer, comprising:
an upper portion of the thickness of the second layer, having a lower index of refraction of the graded index of refraction;
a middle portion of the thickness of the second layer, having a higher index of refraction of the graded index of refraction; and
a lower portion of the thickness of the second layer, having a lower index of refraction of the graded index of refraction.

15. A method of making a film layer having a graded index of refraction through a thickness of the film layer, comprising:
using a sputtering source and physical vapor deposition (PVD) to deposit the film layer; and
varying gas flows over time during the physical vapor deposition, with oxygen gas flow decreasing while nitrogen gas flow is increasing followed by the nitrogen gas flow decreasing while the oxygen gas flow is increasing, to deposit:
an upper portion of the thickness of the film layer, having a lower index of refraction of the graded index of refraction;
a middle portion of the thickness of the film layer, having a higher index of refraction of the graded index of refraction; and
a lower portion of the thickness of the film layer, having a lower index of refraction of the graded index of refraction.

16. The method of making the film layer having the graded index of refraction through the thickness of the film layer of claim 15, further comprising:
depositing a first layer on a substrate, wherein the film layer having the graded index of refraction through the thickness of the film layer is deposited as a second layer over the first layer, after the first layer is deposited, and wherein the first layer has a lower index of refraction than an overall higher index of refraction of the second layer; and
depositing a third layer over the second layer, after the second layer is deposited, wherein the third layer has a lower index of refraction than the overall higher index of refraction of the second layer.

17. The method of making the film layer having the graded index of refraction through the thickness of the film layer of claim 15, further comprising:
depositing further layers on the substrate, as a film layer stack having a plurality of first and second layers, each of the second layers sandwiched by such first layers, such first layers having lower index of refraction than such second layers, each of the second layers having the graded index of refraction through the thickness of the second layer.

18. A method of making a film layer having a graded index of refraction through a thickness of the film layer, comprising:
using at least one sputtering source and physical vapor deposition (PVD) to deposit the film layer on a substrate; and
positioning or moving the substrate, relative to the at least one sputtering source, during the physical vapor deposition, in a first zone having lower index of refraction material deposition, a second zone having higher index of refraction material deposition, and a third zone having lower index of refraction material deposition, to deposit:
an upper portion of the thickness of the film layer, having a lower index of refraction of the graded index of refraction;
a middle portion of the thickness of the film layer, having a higher index of refraction of the graded index of refraction; and
a lower portion of the thickness of the film layer, having a lower index of refraction of the graded index of refraction.

19. The method of making the film layer having the graded index of refraction through the thickness of the film layer of claim 18, further comprising:
depositing a first layer on a substrate, wherein the film layer having the graded index of refraction through the thickness of the film layer is deposited as a second layer over the first layer, after the first layer is deposited, and wherein the first layer has a lower index of refraction than an overall higher index of refraction of the second layer; and
depositing a third layer over the second layer, after the second layer is deposited, wherein the third layer has a lower index of refraction than the overall higher index of refraction of the second layer.

20. The method of making the film layer having the graded index of refraction through the thickness of the film layer of claim 18, further comprising:
depositing further layers on the substrate, as a film layer stack having a plurality of first and second layers, each of the second layers sandwiched by such first layers, such first layers having lower index of refraction than such second layers, each of the second layers having the graded index of refraction through the thickness of the second layer.
